(19) United States
(12) Patent Application Publication
(10) Pub. No.: US 2025/0234135 A1
(43) Pub. Date: Jul. 17, 2025

(54) SOUNDING DEVICE

(71) Applicant: MERRY ELECTRONICS (SUZHOU) CO., LTD., Jiangsu Province (CN)

(72) Inventors: Jiawei Zhu, Jiangsu Province (CN); Mingya Luo, Jiangsu Province (CN)

(73) Assignee: MERRY ELECTRONICS (SUZHOU) CO., LTD., Jiangsu Province (CN)

(21) Appl. No.: 18/978,804

(22) Filed: Dec. 12, 2024

(30) Foreign Application Priority Data
Jan. 15, 2024 (CN) 202410057104.X

(51) Int. Cl. H04R 9/02; H04R 7/06

(52) U.S. Cl. CPC H04R 9/025; H04R 7/06

(57) ABSTRACT

Provided is a sounding device, including a diaphragm, a bracket, a magnetic circuit system, and a voice coil. The bracket surrounds the diaphragm and supports the diaphragm. The magnetic circuit system forms a magnetic gap area. The voice coil is arranged in the magnetic gap area and drives the diaphragm to vibrate. The diaphragm includes at least two conductive portions spaced apart from each other, the bracket is connected to the conductive portions, and the voice coil is electrically connected to an external power source via the conductive portions.

### CROSS-REFERENCE TO RELATED APPLICATIONS

The present application claims the priority of Chinese Patent Application No. 202410057104.X, entitled “Sounding Device”, and filed with the China National Intellectual Property Administration on Jan. 15, 2024, which is incorporated in the present disclosure by reference in its entirety.

### TECHNICAL FIELD

The present disclosure relates to the technical field of electroacoustic transducers, in particular to a sounding device.

### BACKGROUND

A speaker converts electrical signals into sound, commonly found in devices such as audio electronics and mobile phones. The speaker generates sound by providing electrical signals to a voice coil arranged in a magnetic field. When current passes through the voice coil, the voice coil vibrates due to Lorentz force, thereby driving a diaphragm and a dome connected to the voice coil to produce sound.

At present, the voice coil of the speaker is electrically connected to a pad by a lead or to another circuit by an FPC (Flexible Printed Circuit). When the voice coil is connected to the lead, the vibration of the speaker may lead to collision between the lead and other parts, causing break of the lead or noise. When the voice coil is connected to the FPC, the FPC needs to be arranged in the speaker, which increases an additional process, makes the manufacture process complex, increases the manufacture cost, and ultimately leads to an expensive finished product.

### SUMMARY

Embodiments of the present disclosure provide a sounding device, which has high durability and low manufacture cost.

The sounding device includes: a diaphragm, a bracket, a magnetic circuit system, and a voice coil. The diaphragm includes at least two conductive portions spaced apart from each other. The bracket surrounds the diaphragm, and an outer side of the diaphragm is connected to the bracket. The magnetic circuit system is arranged on one side of the bracket and configured to form a magnetic gap area. The voice coil is arranged in the magnetic gap area formed by the magnetic circuit system and drives the diaphragm to vibrate. The voice coil is electrically connected to an external power source via the at least two conductive portions.

In one or more embodiments, the diaphragm further includes an insulating portion, the at least two conductive portions are connected to the insulating portion, and an outer side of the insulating portion is connected to the bracket.

In one or more embodiments, the sounding device further includes a dome, the diaphragm is annular and surrounds the dome, and the voice coil is arranged on one side of the dome.

In one or more embodiments, the at least two conductive portions and the insulating portion are alternately arranged and jointly form the diaphragm.

In one or more embodiments, the conductive portion includes a first fixing end, a first connection structure, and a second fixing end, and the first connection structure connects the first fixing end and the second fixing end. The insulating portion includes a third fixing end, a second connection structure, and a fourth fixing end, and the second connection structure connects the third fixing end and the fourth fixing end. The first fixing end and the third fixing end jointly form a first fixing structure connected to the bracket, and the second fixing end and the fourth fixing end jointly form a second fixing structure connected to the dome.

In one or more embodiments, the first fixing end and the third fixing end are arranged on the outer side of the annular diaphragm, and the second fixing end and the fourth fixing end are arranged on an inner side of the annular diaphragm.

In one or more embodiments, a conduction structure is provided on a side of the dome close to the voice coil, one end of the conduction structure is between the voice coil and the dome, and the other end of the conduction structure is connected to the second fixing end.

In one or more embodiments, the second fixing structure is attached to a first surface of the dome close to the voice coil, a second surface of the dome away from the voice coil, and a third surface of the dome, and the third surface connects the first surface and the second surface.

In one or more embodiments, the insulating portion has a first surface and a second surface opposite to each other, the first surface abuts against the dome, and the at least two conductive portions are arranged on the second surface.

In one or more embodiments, an end of the diaphragm away from the bracket is between the dome and the voice coil, and the conductive portion abuts against the voice coil.

In one or more embodiments, the bracket includes a connector corresponding to a conductive portion of the at least two conductive portions, and the connector is electrically connected to the conductive portion.

In one or more embodiments, the diaphragm partially wraps the bracket, and the diaphragm extends from a side of the bracket close to the voice coil to a side of the bracket away from the voice coil.

In one or more embodiments, the conductive portion includes a a body and conductive particles dispersed in the body.

In one or more embodiments, the body is made of silicone, the conductive particles are made of one or more of gold, silver, copper, zinc, and graphite, and the conductive particles are of linear structures.

In one or more embodiments, the body is made of silicone, the conductive particles are made of one or more of gold, silver, copper, zinc, and graphite, and the conductive particles are of sheet structures.

In one or more embodiments, the body is made of silicone, the conductive particles are made of one or more of gold, silver, copper, zinc, and graphite, and the conductive particles are of linear and sheet structures.

The embodiments of the present disclosure provide a sounding device, including a diaphragm, a bracket, a magnetic circuit system, and a voice coil. The bracket is arranged on the outer side of the diaphragm and provides support for the diaphragm. The voice coil, in the magnetic gap area formed by the magnetic circuit system, drives the diaphragm to vibrate. The diaphragm includes at least two conductive portions spaced apart from each other, and the voice coil is electrically connected to the external power source via the conductive portions. The conductive portions of the diaphragm provide the electrical conductive path between the voice coil and the external power source, so that the sounding device has a relatively simple electrical conductive path, low production cost, and high durability.

### BRIEF DESCRIPTION OF DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is an exploded view of a sounding device according to one or more embodiments of the present disclosure;

FIG. 2 is a cross-sectional view of the sounding device in FIG. 1;

FIG. 3 is a cross-sectional view of another sounding production device according to one or more embodiments of the present disclosure;

FIG. 4 is a cross-sectional view of another sounding device according to one or more embodiments of the present disclosure;

FIG. 5 is a cross-sectional view of another sounding device according to one or more embodiments of the present disclosure; and

FIG. 6 is an exploded view of the sounding device in FIG. 5.

### REFERENCE NUMERALS

1—diaphragm; 11—conductive portion; 111—first fixing end; 112—first connection structure; 113—second fixing end; 12—insulating portion; 121—third fixing end; 122—second connection structure; 123—fourth fixing end; 124—hollow; 13—first fixing structure; 131—third connecting piece; 132—fourth connecting piece; 14—second fixing structure; 141—first connecting piece; 142—second connecting piece;
2—bracket; 21—connector; 22—auxiliary connection structure;
3—dome; 31—conduction structure;
4—voice coil.

### DETAILED DESCRIPTION

The present disclosure is described below based on embodiments, but the present disclosure is not only limited to these embodiments. In the following detailed description of the present disclosure, some specific details are described. The present disclosure can also be fully understood by those skilled in the art without the description of these details. In order to avoid confusing the essence of the present disclosure, well-known methods, processes, flows, elements, and circuits are not described in detail.

Moreover, those of ordinary skill in the art should understand that the accompanying drawings provided herein are for the purpose of illustration only, and the accompanying drawings are not necessarily drawn to scale.

Unless otherwise specified and limited, the terms “mounted”, “connected”, “connection”, “fixed”, and the like should be understood in a broad sense. For example, the “connection” may be fixed connection, detachable connection, integration, mechanical connection, electrical connection, direct connection, indirect connection by a medium, internal communication of two elements, or interaction between two elements. Those of ordinary skill in the art can understand the specific meanings of the above terms in the present application according to specific circumstances.

For ease of explanation, the spatial terms such as “inside”, “outside”, “below”, “under”, “lower part”, “above”, and “upper part” are used here to describe the relationship between one element or feature and the other element or feature illustrated in the figures. Understandably, the spatial terms are intended to include different orientations of a device during use or operation, besides those depicted in the figures. For example, if the device in the figures is flipped, the element described as being “under” or “below” the other element or feature will be positioned “above” the other element or feature. Therefore, the example term “below” can encompass both the directions above and below. The device can be oriented in other ways (rotated 90 degrees or in other orientations), and the spatial descriptors used here should be explained accordingly.

Unless explicitly required by the context, the terms such as “include” and “contain” in the entire application document should be interpreted as including rather than exclusive or exhaustive, that is, “include but not limited to”.

In the description of the present application, it should be understood that the terms “first”, “second”, etc. are only used for descriptive purposes and cannot be understood as indicating or implying relative importance. Moreover, in the description of the present application, unless otherwise stated, “a plurality of” means two or more.

In the description of the present disclosure, it should be noted that the embodiments in the present disclosure and the features in the embodiments can be combined with each other on a non-conflict basis.

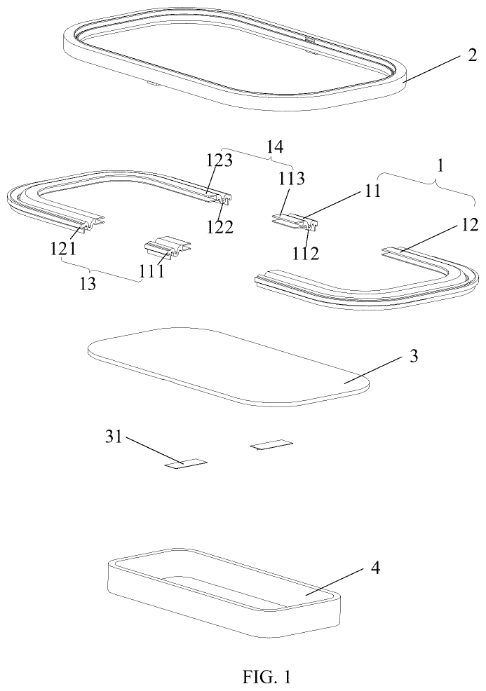

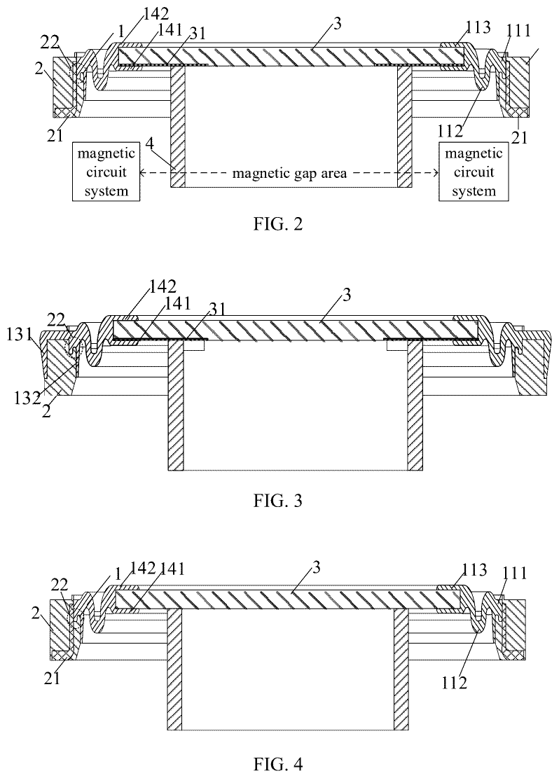

FIG. 1 is an exploded view of a sounding device according to one or more embodiments of the present disclosure, and FIG. 2 is a cross-sectional view of the sounding device in FIG. 1. As shown in FIG. 1 and FIG. 2, the sounding device includes: a diaphragm 1, a bracket 2, a magnetic circuit system, and a voice coil 4. The bracket 2 surrounds the diaphragm 1 and is connected to an outer edge of the diaphragm 1, so that the bracket 2 supports the diaphragm 1. The diaphragm 1 includes at least two conductive portions 11 spaced apart from each other. The voice coil 4 is electrically connected to an external power source via the conductive portions 11, thereby conducting the voice coil 4 and providing electrical signals to the voice coil 4. In this way, the voice coil drives the diaphragm to vibrate in a magnetic gap area defined by the magnetic circuit system. After electrical signals are supplied to the voice coil 4 via the conductive portions 11, the voice coil 4 moves under Lorentz force, the voice coil 4 drives the diaphragm 1 to vibrate together, and the sounding device produces sound.

In one or more embodiments, the diaphragm 1 includes an insulating portion 12, the conductive portion 11 is arranged on the insulating portion 12, and an outer side of the insulating portion 12 is connected to the bracket 2. Two ends of the voice coil 4 are connected to positive and negative electrodes of the power source, respectively. The two conductive portions 11 are connected by the insulating portions 12 in order to prevent a short circuit between the conductive portions 11. In addition, the insulating portion 12 is connected to the bracket 2, which increases the connection area between the diaphragm 1 and the bracket 2 and improves the stability of the sounding device.

In one or more embodiments, the sounding device further includes a dome 3, the diaphragm 1 is annular and surrounds the dome 3, and the voice coil 4 is arranged on one side of the dome 3. In order to increase the rigidity of piston type translation of the diaphragm 1, the dome 3 is connected to an inner edge of the diaphragm 1, and the diaphragm 1 has an annular structure.

In one or more embodiments, the insulating portion 12 is made of a flexible and insulating material, such as silicone or rubber. The conductive portion 11 is made of a conductive composite material. For example, the conductive portion 11 includes a body, in which conductive particles are uniformly dispersed. In this embodiment, the material of the body is identical to the material of the insulating portion 12, making it easy to bond the conductive portion 11 and the insulating portion 12. The conductive particles include one or more of gold, silver, copper, zinc, and graphite. To further enhance the conductivity of the conductive portion 11, the conductive particles are of linear and/or sheet structures. After the conductive composite material including the conductive particles in the linear and/or sheet structures is cured, the conductive particles in the conductive composite material are in line contact and/or surface contact, so the contact between conductive particles has a large area. In this way, the conductive portion 11 has lower and more stable resistivity, the risk of overheating of the conductive portion 11 is reduced, energy loss is reduced, and energy utilization is increased. In addition, the conductive particles in linear and/or sheet structures have smaller volumes than granular conductive particles under the same base area. That is, the conductive particles in the linear and/or sheet structures reduce the volume of conductive particles in the conductive portion 11 and lower the production cost of the conductive portion 11. Moreover, the conductive particles in the linear and/or sheet structures in the cured conductive portion 11 increase the structural strength of the conductive portion 11. The material and shape of the conductive particles are determined according to specific usage requirements. In some embodiments, the conductive particles are of a same material and a same shape. In some other embodiments, the conductive particles are of different materials and/or different shapes.

In some embodiments, both the conductive portion 11 and the insulating portion 12 are of approximately arc-shaped structures, and multiple conductive portions 11 and multiple insulating portions 12 are alternately arranged and bonded to form the diaphragm 1. For example, the conductive portions 11 and the insulating portions 12 are segments of the annular diaphragm 1. As shown in FIG. 1, the diaphragm 1 includes two insulating portions 12 with longer arc lengths and two conductive portions 11 with shorter arc lengths. Each conductive portion 11 includes a first fixing end 111, a first connection structure 112, and a second fixing end 113. As shown in FIG. 1, the first fixing end 111 is arranged on the outer side of the annular diaphragm 1, and the second fixing end 113 is arranged on the inner side of the annular diaphragm 1. The first connection structure 112 connects the first fixing end 111 and the second fixing end 113. Each insulating portion 12 includes a third fixing end 121, a second connection structure 122, and a fourth fixing end 123. As shown in FIG. 1, the third fixing end 121 is arranged on the outer side of the annular diaphragm 1, and the fourth fixing end 123 is arranged on the inner side of the annular diaphragm 1. The second connection structure 122 connects the third fixing end 121 and the fourth fixing end 123. The shapes of the attached sides of the first fixing end 111 and the third fixing end 121 are the same, so that multiple first fixing ends 111 and multiple third fixing ends 121 jointly form an annular first fixing structure 13 positioned on the outer side of the annular diaphragm 1. The first fixing structure 13 is connected to the bracket 2. The shapes of the attached sides of the second fixing end 113 and the fourth fixing end 123 are the same, so that multiple second fixing ends 113 and multiple fourth fixing ends 123 jointly form an annular second fixing structure 14 positioned on the inner side of the annular diaphragm 1. The second fixing structure 14 is connected to an outer edge of the dome 3. The first connection structure 112 and the second connection structure 122 have a same bent structure, which can better drive the dome 3 to move when the voice coil 4 vibrates. In this embodiment, both the first connection structure 112 and the second connection structure 122 have two connected curved surfaces that bend in opposite directions.

In this embodiment, the dome 3 is of a sheet structure, the surface, perpendicular to an axis direction of the voice coil 4, of the sheet structure is a rectangle with round corners, and the second fixing structure 14 has an annular structure that matches the dome 3 and an outer edge that completely wraps the rounded rectangle of the dome 3. As shown in FIG. 2, the second fixing structure 14 includes a first connecting piece 141 and a second connecting piece 142 both protruding in a direction towards the dome 3, and the first connecting piece 141 and the second connecting piece 142 jointly clamp the outer edge of the dome 3. The outer edge of the dome 3 includes a first surface close to the voice coil 4, a second surface away from the voice coil 4, and a third surface connecting the first surface and the second surface. The first connecting piece 141 is attached to the first surface of the outer edge of the dome 3, and the second connecting piece 142 is attached to the second surface of the outer edge of the dome 3. The connection piece connecting the first connecting piece 141 and the second connecting piece 142 is attached to the third surface of the dome 3. The second fixing structure 14 is attached to the three surfaces of the dome 3 to enhance the reliability of connection between the diaphragm 1 and the dome 3. A conduction structure 31 is provided on the surface of the dome 3 on the side close to the voice coil 4, and the conduction structure 31 is arranged close to the edge of the dome 3. The conduction structure 31 corresponds to the conductive portion 11, and the width of the conduction structure 31 is less than or equal to that of the conductive portion 11. One end of the conduction structure 31 is between the voice coil 4 and the dome 3 and is electrically connected with a lead of the voice coil 4, and the other end of the conduction structure 31 is electrically connected to the first fixing end 113 of the conductive portion 11, so that the conductive portion 11 is electrically connected the voice coil 4 by the conduction structure 31. In this embodiment, the material of the conduction structure 31 may be copper, nickel, or other metals, and the conduction structure 31 may be a coating or plating layer is on the dome 3. In some other embodiment, the conduction structure 31 may be a simple FPC, which is bonded or soldered to the dome 3. Input wire and output wires of the voice coil 4 are connected to corresponding conduction structure 31.

Further, the dome 3 may be made of a conductive material or an insulating material. When the dome 3 is made of a conductive material, there is an insulating film (not shown) between the dome 3 and the conduction structure 31. The insulating film can prevent the dome 3 from being electrically connected to the charged conduction structure 31 when the conduction structure 31 is electrically connected to the voice coil 4. When the dome 3 is made of an insulating material, the conduction structure 31 is directly arranged on the surface of the dome 3.

The bracket 2 is of an annular structure with certain stiffness, and the bracket 2 is connected to an outer edge of the first fixing structure 13 to support the diaphragm 1. In one or more embodiments provided by the present disclosure, the bracket 2 is provided with a connector 21 made of a conductive material such as metal or alloy. The bracket 2 is manufactured by injection molding, the connector 21 is provided in the injection molding process, and the position and quantity of the connector 21 correspond to those of the conductive portion 11. In this embodiment, two connectors 21 are located on two longer sides of the bracket 2 respectively. The connector 21 has an L-shaped structure, the vertical part of the L-shaped structure is at least partially exposed from an inner side of the bracket 2 and attached to the conductive portion 11, and the horizontal part of the “L” is exposed from a side wall adjacent to the inner wall of the bracket 2 and connected to the external power source (not shown). When the first fixing structure 13 is connected to the bracket 2, the conductive portion 11 abuts against the connector 21 and is electrically connected to the connector 21, so that the conductive portion 11 is connected to the external power source and the voice coil 4 by the connector 21.

In one or more embodiments, the bracket 2 has an auxiliary connection structure 22 on the side close to the diaphragm 1, and the auxiliary connection structure 22 includes a groove close to the connector 21 and a protrusion on the side of the groove away from the connector 21. The first fixing structure 13 extends into the groove and has a depression corresponding to the protrusion. Such a structure can increase the contact area between the first fixing structure 13 and the bracket 2, and make the connection between the bracket 2 and the first fixing structure 13 tighter. The groove provided on the side close to the connector 21 further increases the contact area between the conductive portion 11 and the connector 21 and improves the stability of conduction between the two.

FIG. 3 is a cross-sectional view of a sounding device provided by embodiments of the present disclosure. In this embodiment, the second fixing structure 14 of the diaphragm 1 and the structure of the dome 3 are the same as those in the embodiment in FIG. 1, and will not be repeated here. In this embodiment, the bracket 2 is not provided with the connector 21, the first fixing structure 13 partially wraps the bracket 2, the first fixing end 111 in the first fixing structure 13 that wraps the bracket 2 is directly connected to the external power source (not shown), thereby simplifying the structure and manufacturing process of the bracket 2. As shown in FIG. 3, the bracket 2 includes a first surface on the side close to the diaphragm 1, a second surface away from the diaphragm 1, and a third surface connecting the first surface and the second surface. The third surface is on the side away from the voice coil 4 in the figure (a top surface of the bracket 2 in FIG. 3), and the bracket 2 further includes an auxiliary connection structure 22 arranged at the connection between the first surface and the third surface. The first fixing structure 13 includes a third connecting piece 131 and a fourth connecting piece 132, the third connecting piece 131 wraps the second surface and third surface of the bracket 2, and the fourth connecting piece 132 covers the first surface. The auxiliary connection structure 22 is attached to the connection between the third connecting piece 131 and the fourth connecting piece 132. In this embodiment, the auxiliary connection structure 22 has a groove close to a side wall of the bracket 2 and a protrusion arranged on the side of the groove away from the bracket 2. The first fixing structure 13 extends into the groove and wraps the protrusion, to increase the contact area between the first fixing structure 13 and the bracket 2 and increase the strength of connection between the first fixing structure 13 and the bracket 2.

FIG. 4 is a cross-sectional view of a sounding device provided in embodiments of the present disclosure. In this embodiment, the first fixing structure 13 of the diaphragm 1 and the connection structure of the bracket 2 are the same as those in the embodiment in FIG. 1. In this embodiment, the dome 3 is a whole circuit board, and the dome 3 includes a first surface close to the voice coil 4, a second surface away from the voice coil 4, and a third surface connecting the first surface and the second surface. The circuit structure of the dome 3 may be only arranged on the first surface or may be arranged on both the first surface and the second surface. The second fixing structure 14 includes a first connecting piece 141 and a second connecting piece 142 both protruding in the direction towards the dome 3, and the first connecting piece 141 and the second connecting piece 142 jointly clamp the two opposite surfaces of the dome 3. The first connecting piece 141 is attached to an edge of the first surface, and the second connecting piece 142 is attached to an edge of the second surface. The connection between the first connecting piece 141 and the second connecting piece 142 is attached to the third surface of the dome 3. The second fixing structure 14 is attached to the three surfaces of the dome 3 to enhance the reliability of connection between the diaphragm 1 and the dome 3. When the circuit structure is arranged only on the first surface of the dome 3, the second connecting piece 142 plays a connecting and fixing role. When the circuit structure is arranged on both the first surface and second surface of the dome 3, the second fixing structure 14 including the first connecting piece 141 and the second connecting piece 142 is electrically connected to the circuit structure from two sides. The first surface of the dome 3 abuts against the voice coil 4, and the lead of the voice coil 4 is electrically connected to the circuit structure on the dome 3, so that the dome 3 directly conducts the conductive portion 11 and the voice coil 4. In this embodiment, the conduction structure 31 is not provided in the sounding device, so the sounding device has a relatively simple structure, and the manufacturing steps of the sounding device are also simple.

In the above embodiments, in the manufacturing process of the diaphragm 1, the conductive composite material doped with conductive particles that forms the conductive portions 11 is injected into a mold in a step, and the insulating material that forms the insulating portions 12 is injected into the mold in another step. The order of injecting the conductive composite material and injecting of the insulating material is determined according to actual production needs, but the latter material is injected after the former material is cured to prevent mixing of the conductive composite material and the insulating material. Because the body in the conductive composite material and the insulating material forming the insulating portions 12 are the same material, the conductive portion 11 and the insulating portion 12 formed in the same mold one after another are well connected.

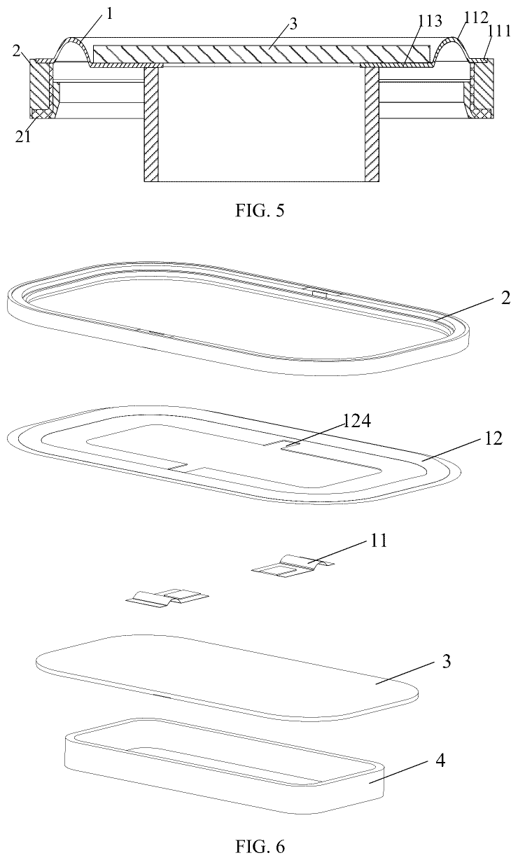

FIG. 5 is a cross-sectional view of a sounding device provided in embodiments of the present disclosure, and FIG. 6 is an exploded view of the sounding device shown in FIG. 5. In this embodiment, the insulating portion 12 is of an annular structure, which may be a circular ring, an elliptical ring, a rounded rectangular ring as shown in FIG. 6, or other shapes. The annular insulating portion 12 has a first surface and a second surface opposite to each other, the first surface abuts against the dome 3, and the conductive portion 11 is arranged on the second surface. In this embodiment, the insulating portion 12 may be made of PEEK (Polyetheretherketone) or TPU (Thermoplastic Urethane). In the manufacturing process of the diaphragm 1, the insulating portion 12 is first formed, and then the conductive portion 11 is formed or sprayed on a predetermined position of the formed insulating portion 12. A portion of the insulating portion 12 on the side close to the voice coil 4 has a smaller thickness, and the conductive portion 11 formed on this part of the insulating portion 12 is also relatively thin, so the end of the diaphragm 1 close to the voice coil 4 can directly extend between the dome 3 and the voice coil 4, and the conductive portion 11 abuts against the voice coil 4. The conduction structure 31 is also not provided in the sounding device in this embodiment, and the voice coil 4 is directly conducted with the conductive portion 11 of the diaphragm 1. In this embodiment, both the first connection structure 112 and the second connection structure 122 have a curved surface that bends away from the voice coil 4.

Further, a predetermined area, for arranging the conductive portion 11, of the insulating portion 12 is hollowed to form a hollow 124. The conductive portion 11 is partially arranged in the hollow 124, and the thickness of the conductive portion 11 in the hollow 124 is the same as that of the peripheral insulating portion 12, which can increase the volume of the conductive portion 11, reduce the resistance of the conductive portion 11, reduce the heat generation of the conductive portion 11, and improve the conducting capacity of the conductive portion 11, so that the transmission of electrical energy when the conductive portion 11 conducts the voice coil 4 is more stable.

In the above embodiments of the present disclosure, the diaphragm 1 has two conductive portions 11, and the two conductive portions 11 are arranged at middle parts of long sides of the diaphragm 1, respectively. In other embodiments, the quantity and position of the conductive portion 11 are determined according to usage requirements, not limited to any position on any side of the diaphragm, so that the design of the lead position of the voice coil and the terminal position of the external power source can be more flexible.

The embodiments of the present disclosure provide a sounding device, including a diaphragm, a bracket, a magnetic circuit system, and a voice coil. The diaphragm includes at least two conductive portions spaced apart from each other. The conductive portions are integrated on the diaphragm to reduce the space occupied by the conduction structure, so that there is a larger space for other components in the sounding device. The body of the conductive composite material that forms the conductive portions has toughness, which can avoid the risk of fracture of the conductive portions and improve the product reliability of the sounding device. And due to the large area and low internal resistance of the conductive portions, energy utilization can be improved.

Through the above structure, the conductive portions are integrated in the diaphragm to conduct the voice coil, so that the sounding device has a relatively simple conduction structure, low production cost, and high durability.

Described above are merely the exemplary embodiments of the present disclosure, and the present disclosure is not limited thereto. Various modifications and variations may be made to the present disclosure for those skilled in the art. Any modifications, equivalent substitutions, improvements, and the like made within the spirit and principle of the present disclosure shall fall within the protection scope of the present disclosure.

What is claimed is:

1. A sounding device, comprising:
a diaphragm comprising at least two conductive portions spaced apart from each other;
a bracket surrounding the diaphragm, an outer side of the diaphragm being connected to the bracket;
a magnetic circuit system arranged on one side of the bracket and configured to form a magnetic gap area; and
a voice coil arranged in the magnetic gap area formed by the magnetic circuit system and configured to drive the diaphragm to vibrate,
wherein the voice coil is electrically connected to an external power source via the at least two conductive portions.

2. The sounding device according to claim 1, wherein the diaphragm further comprises an insulating portion, the at least two conductive portions are connected to the insulating portion, and an outer side of the insulating portion is connected to the bracket.

3. The sounding device according to claim 2, further comprising a dome, wherein the diaphragm is annular and surrounds the dome, and the voice coil is arranged on one side of the dome.

4. The sounding device according to claim 3, wherein the at least two conductive portions and the insulating portion are alternately arranged and form the diaphragm.

5. The sounding device according to claim 4, wherein each conductive portion comprises a first fixing end, a first connection structure, and a second fixing end, and the first connection structure connects the first fixing end and the second fixing end;
the insulating portion comprises a third fixing end, a second connection structure, and a fourth fixing end, and the second connection structure connects the third fixing end and the fourth fixing end; and
the first fixing end and the third fixing end jointly form a first fixing structure connected to the bracket, and the second fixing end and the fourth fixing end jointly form a second fixing structure connected to the dome.

6. The sounding device according to claim 5, wherein the first fixing end and the third fixing end are arranged on the outer side of the annular diaphragm, and the second fixing end and the fourth fixing end are arranged on an inner side of the annular diaphragm.

7. The sounding device according to claim 5, wherein a conduction structure is provided on a side of the dome close to the voice coil, one end of the conduction structure is between the voice coil and the dome, and the other end of the conduction structure is connected to the second fixing end.

8. The sounding device according to claim 7, wherein the second fixing structure is attached to a first surface of the dome close to the voice coil, a second surface of the dome away from the voice coil, and a third surface of the dome, and the third surface connects the first surface and the second surface.

9. The sounding device according to claim 3, wherein the insulating portion has a first surface and a second surface opposite to each other, the first surface abuts against the dome, and the at least two conductive portions are arranged on the second surface.

10. The sounding device according to claim 9, wherein an end of the diaphragm away from the bracket is between the dome and the voice coil, and the conductive portion abuts against the voice coil.

11. The sounding device according to claim 2, wherein the bracket comprises a connector corresponding to a conductive portion of the at least two conductive portions, and the connector is electrically connected to the conductive portion.

12. The sounding device according to claim 3, wherein the bracket comprises a connector corresponding to a conductive portion of the at least two conductive portions, and the connector is electrically connected to the conductive portion.

13. The sounding device according to claim 4, wherein the bracket comprises a connector corresponding to a conductive portion of the at least two conductive portions, and the connector is electrically connected to the conductive portion.

14. The sounding device according to claim 9, wherein the bracket comprises a connector corresponding to a conductive portion of the at least two conductive portions, and the connector is electrically connected to the conductive portion.

15. The sounding device according to claim 2, wherein the diaphragm partially wraps the bracket, and the diaphragm extends from a side of the bracket close to the voice coil to a side of the bracket away from the voice coil.

16. The sounding device according to claim 3, wherein the diaphragm partially wraps the bracket, and the diaphragm extends from a side of the bracket close to the voice coil to a side of the bracket away from the voice coil.

17. The sounding device according to claim 1, wherein the conductive portion comprises a body and conductive particles dispersed in the body.

18. The sounding device according to claim 17, wherein the body is made of silicone, the conductive particles are made of one or more of gold, silver, copper, zinc, and graphite, and the conductive particles are of linear structures.

19. The sounding device according to claim 17, wherein the body is made of silicone, the conductive particles are made of one or more of gold, silver, copper, zinc, and graphite, and the conductive particles are of sheet structures.

20. The sounding device according to claim 17, wherein the body is made of silicone, the conductive particles are made of one or more of gold, silver, copper, zinc, and graphite, and the conductive particles are of linear and sheet structures.
